(19) United States
(12) Patent Application Publication
(10) Pub. No.: US 2012/0072798 A1
(43) Pub. Date: Mar. 22, 2012

(54) SEMICONDUCTOR DEVICE

(76) Inventors: Tsutomu Unesaki, Hachioji-shi (JP); Kazuki Okawara, Ome-shi (JP)

(21) Appl. No.: 13/233,096

(22) Filed: Sep. 15, 2011

(30) Foreign Application Priority Data
Sep. 15, 2010 (JP) 2010-207176
Aug. 18, 2011 (JP) 2011-178885

(51) Int. Cl. G06F 11/07

(52) U.S. Cl. 714/746; 714/E11.023

(57) ABSTRACT

According to one embodiment, a semiconductor device includes a NAND flash memory, an error correction unit, and a table. The NAND flash memory is configured to hold data. The error correction unit detects and corrects errors in the data. The table holds information on an error correction method associated with each piece of data. The error correction unit selects an error correction method to be applied for each piece of data in accordance with the information in the table.

### CROSS-REFERENCE TO RELATED APPLICATIONS

This application is based upon and claims the benefit of priority from prior Japanese Patent Applications No. 2010-207176, filed Sep. 15, 2010; and No. 2011-178885, filed Aug. 18, 2011, the entire contents of all of which are incorporated herein by reference.

### FIELD

Embodiments described herein relate generally to a semiconductor device.

### BACKGROUND

NAND flash memories have heretofore been widely used as storage devices. An ECC function has also been widely used in the NAND flash memories. However, the conventional ECC function may require high power consumption.

### BRIEF DESCRIPTION OF THE DRAWINGS

FIG. 1 is a block diagram of a semiconductor device according to a first embodiment;

FIG. 2 is a block diagram of a NAND controller according to the first embodiment;

FIG. 3 is a schematic diagram of a coloring table according to the first embodiment;

FIG. 4 is a flowchart of a write method according to the first embodiment;

FIG. 5 is a schematic diagram of an address translation table according to the first embodiment;

FIG. 6 is a block diagram of an ECC unit according to the first embodiment;

FIG. 7 and FIG. 8 are schematic diagrams of page data according to the first embodiment;

FIG. 9 and FIG. 10 are flowcharts of a read method and a write method according to the first embodiment, respectively;

FIG. 11 is a block diagram of an ECC unit according to a second embodiment;

FIG. 12 is a schematic diagram of page data according to the second embodiment;

FIG. 13 and FIG. 14 are flowcharts of a read method and a write method according to the second embodiment, respectively;

FIG. 15 is a block diagram of an ECC unit according to a third embodiment;

FIG. 16 is a block diagram of a semiconductor device according to a third embodiment;

FIG. 17 is a block diagram of a NAND flash memory according to a fourth embodiment;

FIG. 18 is a schematic diagram of an address translation table according to the fourth embodiment;

FIG. 19 and FIG. 20 are a flowchart and a conceptual diagram of a data copying method according to the fourth embodiment, respectively;

FIG. 21 is a conceptual diagram showing a data copying method according to a modification of the fourth embodiment;

FIG. 22 is a block diagram of a storage device according to a fifth embodiment;

FIG. 23 is a block diagram of a drive control circuit according to the fifth embodiment; and

FIG. 24 is a perspective external view of a personal computer according to the fifth embodiment.

### DETAILED DESCRIPTION

In general, according to one embodiment, a semiconductor device includes: a NAND flash memory; an error correction unit; and a table. The NAND flash memory is configured to hold data. The error correction unit detects and corrects errors in the data. The table holds information on an error correction method associated with each piece of data. The error correction unit selects an error correction method to be applied for each piece of data in accordance with the information in the table.

### First Embodiment

A semiconductor device according to the first embodiment is described below.

1. Configuration of the Semiconductor Device

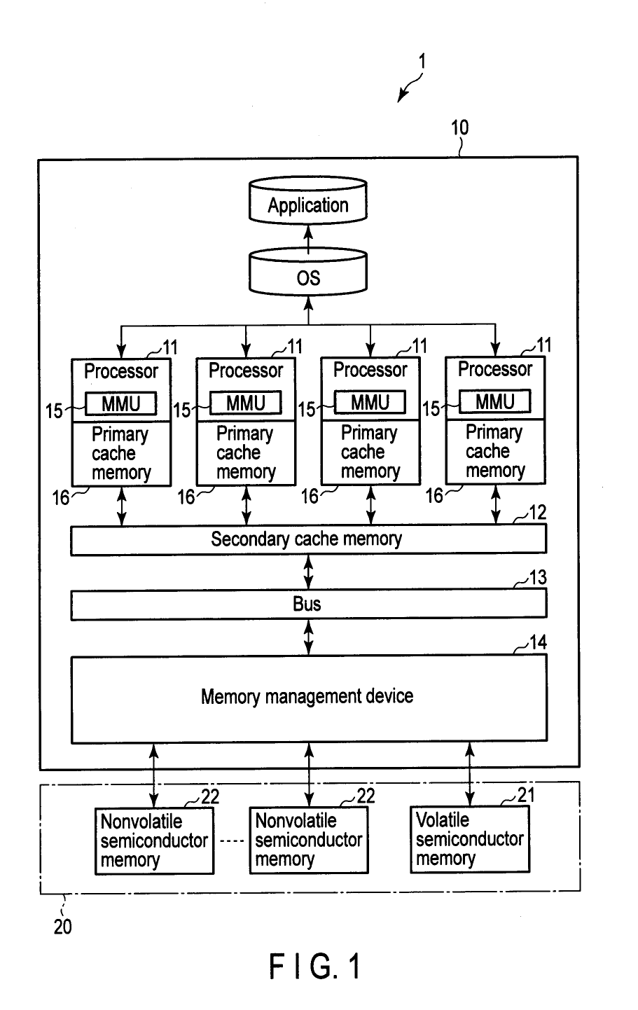

First, the configuration of the semiconductor device according to the present embodiment is described with reference to FIG. 1. FIG. 1 is a block diagram of the semiconductor device according to the present embodiment.

The semiconductor device according to the present embodiment is an information processing system which includes a processor, a NAND flash memory used as a main memory, and a memory management device for managing access to the NAND flash memory.

As shown in FIG. 1, a semiconductor device 1 roughly includes an information processing apparatus 10 and a storage device 20 which are connected to each other to be able to communicate with each other by, for example, a bus. The information processing apparatus 10 and the storage device 20 may be formed on the same semiconductor substrate, or may be formed as separate chips. The storage device 20 includes semiconductor memories. In the present embodiment, the storage device 20 includes a volatile semiconductor memory 21 and nonvolatile semiconductor memories 22.

1.1 Configuration of the Information Processing Apparatus 10

First, the configuration of the information processing apparatus 10 is described. As shown in FIG. 1, the information processing apparatus 10 includes processors 11, a secondary cache memory 12, a bus 13, and a memory management device 14, and is formed by, for example, system on chip (SoC).

Each of the processors 11 includes a primary cache memory 16 and a memory management unit (MMU) 15. As the processor 11, for example, a central processing unit (CPU) is used, but some other processing unit such as a micro processor unit (MPU) or a graphic processor unit (GPU) may be used instead. Although four processors 11 are shown in FIG. 1, one or more processors 11 have only to be provided. The processors 11 share the secondary cache memory 12, and are electrically connected to the memory management device 14 via the bus 13. The processors 11 access the storage device 20 via the memory management device 14. Moreover, the processors 11 read an OS (operating system) from the storage device 20, and execute the OS. The processors 11 also read an application program from, for example, the storage device 20, and execute the application program on the OS.

The memory management device 14 is electrically connected to the volatile semiconductor memory 21 and the nonvolatile semiconductor memories 22 in the storage device 20. The memory management device 14 accesses the storage device 20 in response to the request of the processors 11, and reads data from the storage device 20 or writes data to the storage device 20. The memory management device 14 is capable of operating asynchronously with the processors 11, and performing processing such as wear leveling, garbage collection, and compaction for the nonvolatile semiconductor memory during the execution of processing the processors 11.

1.2 Configuration of the Storage Device 20

Now, the configuration of the storage device 20 is described still referring to FIG. 1. As described above, the storage device 20 includes the volatile semiconductor memory 21 and the nonvolatile semiconductor memories 22.

The volatile semiconductor memory 21 and the nonvolatile semiconductor memories 22 are used as the main memories of the processors 11. In the present embodiment, a sufficient memory capacity is ensured by the nonvolatile semiconductor memories 22, and the capacity of the nonvolatile semiconductor memories 22 is higher than the capacity of the volatile semiconductor memory 21. For example, data likely to be accessed, such as recently accessed data and frequently used data, are cached in the volatile semiconductor memory 21 from the nonvolatile semiconductor memories 22. If there is no access target data in the volatile semiconductor memory 21 when the processors 11 access the volatile semiconductor memory 21, necessary data is transferred to the volatile semiconductor memory 21 from the nonvolatile semiconductor memories 22. The volatile semiconductor memory 21 and the nonvolatile semiconductor memories 22 are used together so that a memory space greater than the capacity of the volatile semiconductor memory 21 is available as the main memory.

In the present embodiment, the volatile semiconductor memory 21 is, for example, a dynamic random access memory (DRAM). However, as the volatile semiconductor memory 21, a memory used as the main memory in a computer, such as a fast page mode DRAM (FPM-DRAM), an extended data out DRAM (EDO-DRAM), or a synchronous DRAM (SDRAM) may be used instead of the DRAM. Instead of the volatile semiconductor memory 21, a nonvolatile random access memory such as a magnetoresistive random access memory (MRAM) or a ferroelectric random access memory (FeRAM) may be used if such a memory is capable of random access as fast as the DRAM and has substantially no limit to the maximum number of times of accessibility. The volatile semiconductor memory 21 has a smaller capacity (e.g., 128 megabytes to 4 gigabytes) than the nonvolatile semiconductor memories 22, but is capable of high-speed access.

The nonvolatile semiconductor memory 22 is, for example, a NAND flash memory in the present embodiment. Thus, the nonvolatile semiconductor memory 22 may be referred to as a NAND flash memory 22 in the explanation below. However, the nonvolatile semiconductor memory 22 may be a different nonvolatile semiconductor memory such as a NOR flash memory. The nonvolatile semiconductor memory 22 has a greater capacity (e.g., 32 gigabytes to 512 gigabytes) than the volatile semiconductor memory 21, but time required for accessing is long.

When the nonvolatile semiconductor memory 22 is a NAND flash memory as in the present embodiment, data is written or read page by page. Data is erased block by block. The block includes pages.

1.3 Configuration of the Memory Management Device 14

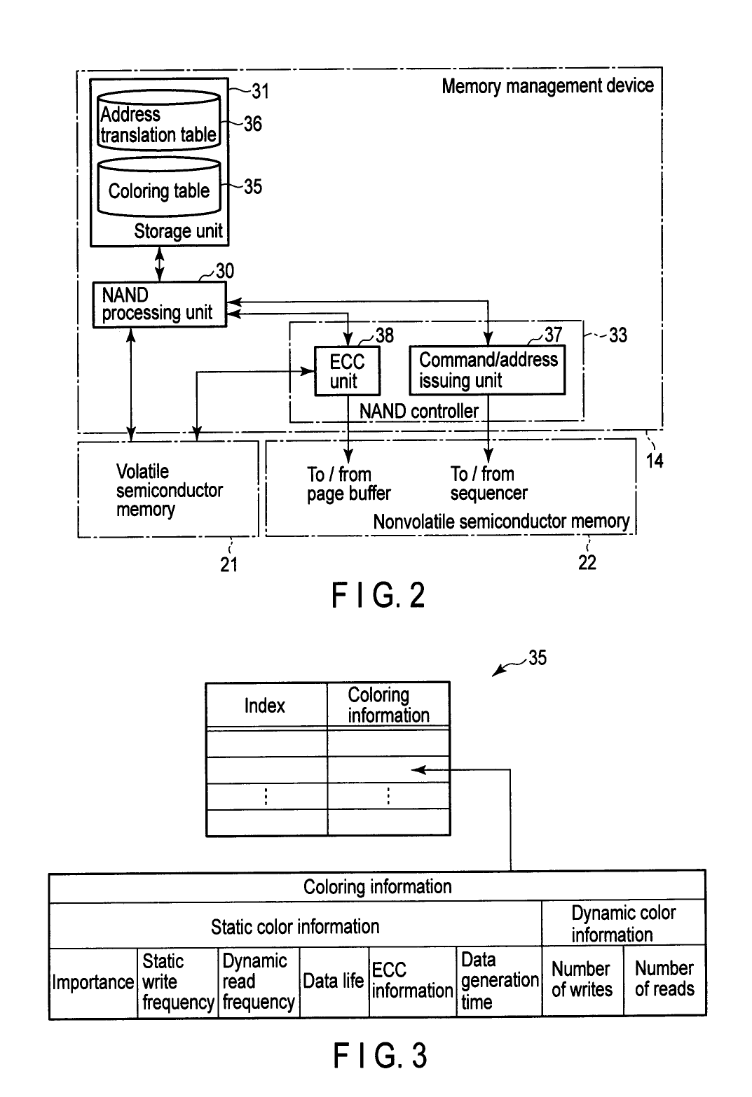

Now, the configuration of the memory management device 14, in particular, the configuration for managing the NAND flash memory 22 is described with reference to FIG. 2. FIG. 2 is a block diagram of the memory management device 14.

1.3.1 Overall Configuration of the Memory Management Device 14

As shown in FIG. 2, the memory management device 14 includes a NAND processing unit 30, a storage unit 31, and a NAND controller 33.

The storage unit 31 may be a volatile semiconductor memory such as a DRAM or a nonvolatile semiconductor memory such as a NOR flash memory. The storage unit 31 holds a coloring table 35 and an address translation table 36. The coloring table 35 holds information that characterizes each piece of data on the basis of various standards (this information is referred to as coloring information). The address translation table 36 holds the relation between an address used to access the memory management device 14 from the processors 11 (hereinafter referred to as a CPU physical address) and an address of an area corresponding to the CPU physical address in the NAND flash memory 22 (hereinafter referred to as a NAND physical address). The information in the coloring table 35 and the address translation table 36 may be provided from the OS or application executed by the processors 11 or may be provided from the NAND processing unit 30. The coloring table 35 and the address translation table 36 will be described in detail later.

The NAND processing unit 30 accepts an access (writing/reading/erasing) to the NAND flash memory 22 from the processors 11. The NAND processing unit 30 instructs the NAND controller 33 to perform processing corresponding to the access. At the same time, the NAND processing unit 30 refers to the address translation table 36 to translate the CPU physical address received from the processor 11 to a NAND physical address, and supplies the NAND physical address to the NAND controller 33. In response to the instruction from the processors 11 and/or independently of the processors 11, the NAND processing unit 30 determines the necessity of the wear leveling, garbage collection, and compaction in the NAND flash memory 22, and instructs the NAND controller 33 to perform such processing if necessary. The NAND processing unit 30 updates the coloring table 35 and the address translation table 36 accordingly. The NAND processing unit 30 may be realized by software for executing the above-mentioned processing, or may be realized by hardware. When the NAND processing unit 30 is realized by software, this software may be held in the NAND flash memory 22. This software may be read from the NAND flash memory 22 by the NAND processing unit 30 and executed when, for example, powered-on.

In response to the instruction from the NAND processing unit 30, the NAND controller 33 controls the access to the NAND flash memory 22. That is, the NAND controller 33 includes a command/address issuing unit 37 and an error checking and correcting (ECC) unit 38.

In response to the instruction from the NAND processing unit 30, the command/address issuing unit 37 issues a write/read/erase command, and outputs the command to the NAND flash memory 22 together with the NAND physical address. The commands and addresses are provided to a sequencer which controls the overall operation of the NAND flash memory 22. The sequencer is enabled on receipt of the command, and starts processing corresponding to the command.

The ECC unit 38 performs error correction processing (which may be referred to as ECC processing) for the data read from the NAND flash memory 22 and the data to be written to the NAND flash memory 22. That is, in reading, the ECC unit 38 generates a syndrome from a parity in the data read from the NAND flash memory 22, and thereby detects errors. When an error is detected, the ECC unit 38 corrects the error. The corrected data is supplied to, for example, the volatile semiconductor memory 21 and/or the processors 11. On the other hand, in writing, the ECC unit 38 receives data from, for example, the processors 11 and/or the volatile semiconductor memory 21. The ECC unit 38 then generates a parity for the received data, adds the generated parity to the received data, and transfers the received data with the parity to a page buffer of the NAND flash memory 22 as the write data.

The ECC unit 38 according to the present embodiment is capable of error correction in accordance with more than one method. At least the OS or application recognizes which error correction method is applied to each piece of data, and such information is held in the coloring table 35 and/or the address translation table 36. Therefore, when receiving the data write and read accesses, the NAND processing unit 30 refers to the coloring table 35 and/or the address translation table 36 to select error correction method to be applied, and informs the ECC unit 38 accordingly.

1.3.2 Coloring Table 35

Now, details of the coloring table 35 are described. In the present embodiment, coloring information is provided for each piece of data. The unit of data to which the coloring information is provided is, for example, the minimum unit of reading and writing. For example, the minimum unit of reading and writing is the page size of the NAND flash memory 22. Although the size of data with which the coloring information is associated by the coloring table 35 is the page size in the explanation below, the present embodiment is not limited to this.

FIG. 3 is a schematic diagram of the coloring table 35. The coloring table 35 associates the coloring information with each piece of data, and stores the coloring information in entry units. An index is given to each entry of the coloring table 35. The index is a value generated on the basis of the CPU physical address. Therefore, when accessed from the processors 11, the NAND processing unit 30 refers to the entry managed by the index corresponding to the received CPU physical address, and can thereby acquire the coloring information for the relevant data.

The coloring information is information specific to each piece of data, and includes static color information and dynamic color information. The static color information is information generated on the basis of the feature of the data to which the coloring information is given, and includes, for example, information serving as a hint for determining an area to locate (write) the data on the storage device 20. The dynamic color information is information including at least one of the number of times and frequency of reading and writing.

As shown in FIG. 3, the static color information includes the importance of the data, the frequency of static writing, the frequency of static reading, data life, ECC information, and the time of data generation. These are described below.

(i) The importance is a value set by estimating the importance of the data on the basis of, for example, the kind of data. The importance is estimated by, for example, the feature of a file held in a file system, or the feature of an area (e.g., a stack area or heap area) temporarily used for a program.

(ii) The frequency of static writing is a value set by estimating the frequency of writing data on the basis of, for example, the kind of data. For example, a high value is set as the frequency of static writing for data that is estimated to be highly frequently written.

(iii) The frequency of static reading is a value set by estimating the frequency of reading data on the basis of, for example, the kind of data. For example, a high value is set as the frequency of static reading for data that is estimated to be highly frequently read.

(iv) The data life is a value set by estimating the period (data life) in which the data is used as data without being erased.

(v) The ECC information is information which is determined by, for example, the kind of data and which regards an error correction method to be used in the ECC unit 38. For example, for data that needs to be read at high speed, the OS, for example, determines to use a method capable of high-speed error correction for the data, and this determination is written to the coloring table 35 as the ECC information.

The static color information is a value that is statically predetermined by the program (process) for generating data. The OS may predict the static color information on the basis of, for example, the file extension or file header of the data. The static color information is recorded in the coloring table 35 by the program or the OS.

Now, the dynamic color information is described. The dynamic color information includes the number of writes and the number of reads. Here, the number of writes is the number of times the data is written to the volatile semiconductor memory 21. The number of reads is the number of times the data is read from the storage device 20.

The dynamic color information is managed by, for example, the NAND processing unit 30. That is, the NAND processing unit 30 increments the number of writing the data whenever the data is written, and increments the number of reading the data whenever the data is read.

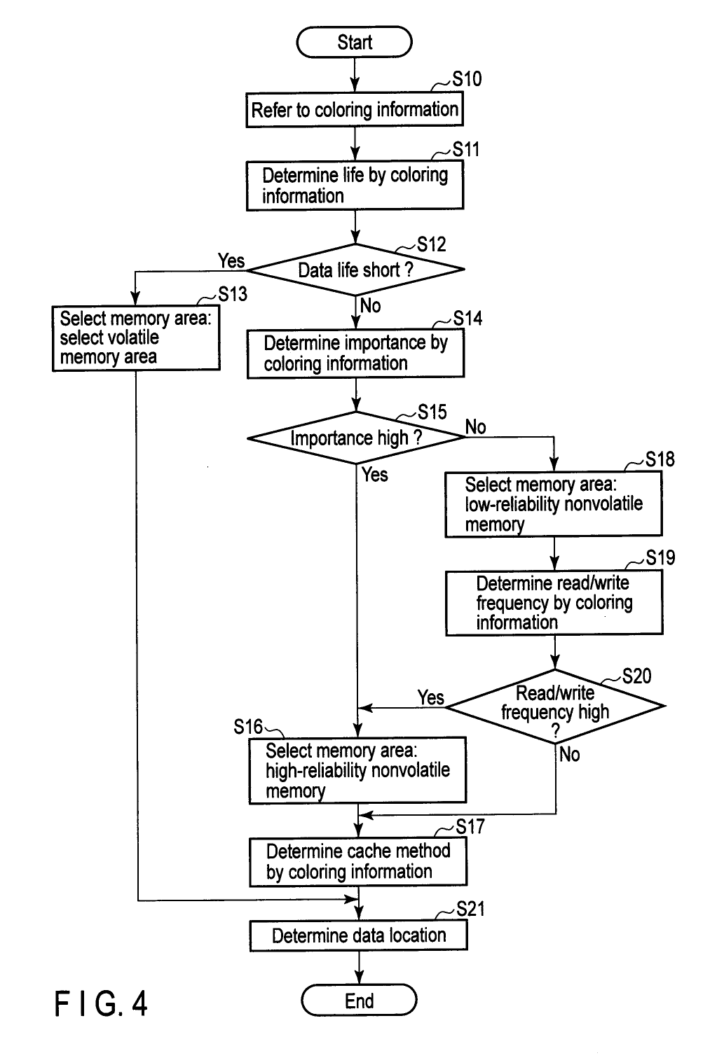

The importance, the frequency of static writing, the frequency of static reading, and the data life can be used to determine, for example, which area of the storage device 20 to store data. Such an example is described with reference to a flowchart in FIG. 4. FIG. 4 is a flowchart showing an example of processing for storing data in the storage device 20.

As shown, in response to a writing request, the NAND processing unit 30 first refers to the coloring information corresponding to data to be written (step S10). The NAND processing unit 30 then refers to the “data life” in the coloring information, and determines the life of the data to be written (step S11).

When determining that the life of the data to be written is short (step S12, YES), the NAND processing unit 30 selects (step S13) and determines (step S21) the volatile semiconductor memory 21 as a memory area to store the data to be written.

When determining in step S11 that the data life is short (step S12, NO), the NAND processing unit 30 refers to the “importance” in the coloring information for the data to be written, and determines the importance of the data to be written (step S14).

When determining in step S14 that the importance of the data to be written is high (step S15, YES), the NAND processing unit 30 selects the highly durable (reliable) nonvolatile semiconductor memory 22 as a memory area to store the data to be written (step S16). The highly durable nonvolatile semiconductor memory 22 is, for example, the NAND flash memory 22 in which each memory cell holds binary (one bit) data (hereinafter referred to as a “single-level-cell (SLC) NAND flash memory 22”). Further, on the basis of the coloring information for the data to be written, the NAND processing unit 30 determines whether to cache the data to be written in the volatile semiconductor memory 21 (a cache method based on the coloring information) (step S17). The NAND processing unit 30 then determines the SLC NAND flash memory 22 as the memory area to store the data to be written (step S12).

When determining in step S14 that the importance is low (step S15, NO), the NAND processing unit 30 selects the low-durability nonvolatile semiconductor memory 22 as a memory area to store the data to be written (step S18). The low-durability nonvolatile semiconductor memory 22 is, for example, the NAND flash memory 22 in which each memory cell holds data having more than two values (two bits or more) (hereinafter referred to as a “multi-level-cell (MLC) NAND flash memory 22”). Further, in accordance with the coloring information for the data to be written (the dynamic color information, the static color information), the NAND processing unit 30 determines the read frequency or write frequency of the data to be written (step S19).

When determining in step S19 that the read frequency or write frequency of the data to be written is high (step S20, YES), the NAND processing unit 30 selects the SLC NAND flash memory 22 as the memory area to store the data to be written (step S16), and moves to step S17.

On the other hand, when determining in step S19 that the read frequency or write frequency is low (step S20, NO), the NAND processing unit 30 keeps the MLC NAND flash memory 22 selected, and moves to step S17.

As described above, the coloring information can be used to determine which memory area to store the data to be written. However, the flowchart in FIG. 4 shows only an example of the determination method, and some other method may be used instead. For example, a memory area may be determined in accordance with dynamic write frequency and read frequency obtained by using the data generation time and a current time.

1.3.3 Address Translation Table 36

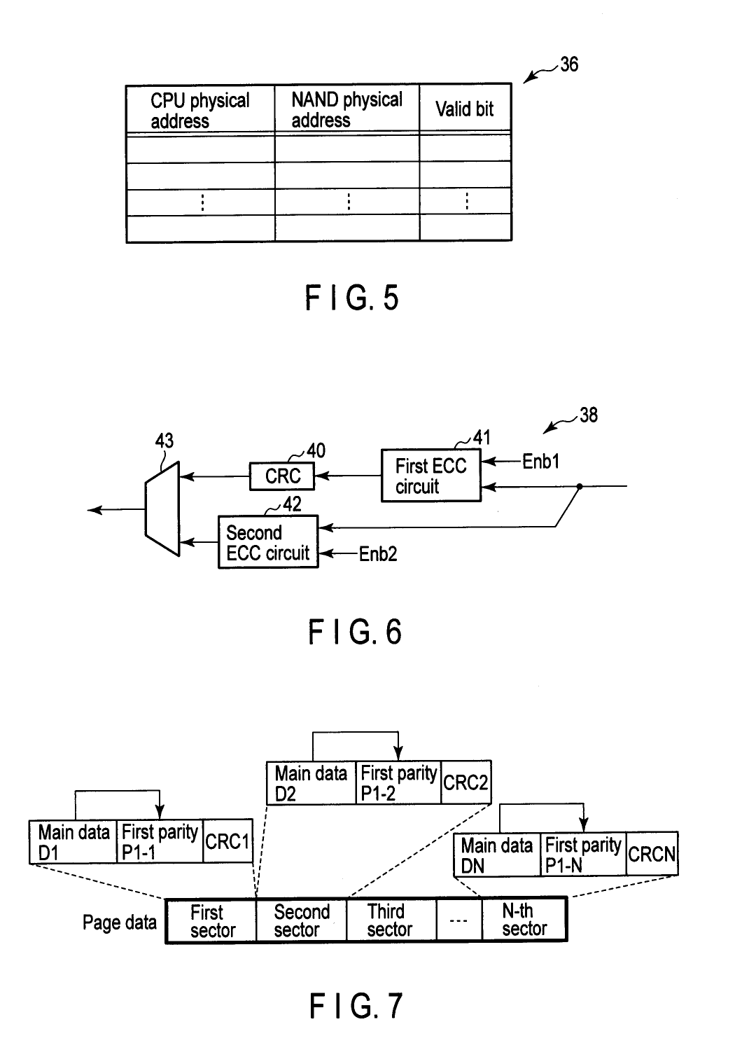

Now, the address translation table 36 is described. FIG. 5 is a schematic diagram of the address translation table 36 according to the present embodiment.

As shown, the address translation table 36 manages the corresponding NAND physical address and valid bit for each CPU physical address in a table format.

Here, the CPU physical address and the NAND physical address are briefly described. As previously described, the CPU physical address is an address used to access the memory management device 14 from the processors 11, and is used by the processors 11 to designate specific data.

In contrast, the NAND physical address is an address of a physical area in the NAND flash memory 22. The data written in the NAND flash memory 22 moves from place to place in the physical area within the NAND flash memory 22. That is, if the NAND physical address of the area in which data corresponding to a CPU physical address ADD_{CPU1} is written first is ADD_{NAND}1, this data then moves to the area of ADD_{NAND}2, moves to the area of ADD_{NAND}3, and further moves to the area of ADD_{NAND}4. That is, the NAND physical address changes with time from ADD_{NAND}1 to ADD_{NAND}2, ADD_{NAND}3, ADD_{NAND}4, . . . . The reason is that updated data has to be written in a different physical area at the time of data update because the NAND flash memory does not permit overwriting of data and that data is periodically moved by the wear leveling or the garbage collection.

Accordingly, it is necessary to always keep track of the relation between the CPU physical address and the NAND physical address, and the address translation table 36 is provided for this purpose.

An entry is allocated to each CPU physical address in the address translation table 36. The corresponding NAND physical address and valid bit are stored in each entry. The valid bit is information that indicates whether the corresponding entry is valid. When the valid bit is “1”, the entry is valid. When the effective bit is “0”, the entry is invalid. The initial value of the valid bit is “0”. The entry when the valid bit is “0” is an entry for which no CPU physical address is mapped, or an entry for which a CPU physical address is mapped but erased later. A CPU physical address is mapped for the entry with the valid bit=“1”, and an area corresponding to this CPU physical address is present in at least one of the volatile semiconductor memory 21 and the NAND flash memory 22.

The entries of the address translation table 36 may be allocated by the page unit of the NAND flash memory 22 as in the coloring table 35. An example of such a case is further described below. However, it should be understood that the present embodiment is not limited to this case, and entries can be allocated to various sizes.

2. Operation of the Semiconductor Device 1

Now, the operation of the semiconductor device 1 having the above-described configuration is described below in connection with the operation of the memory management device 14 during reading and writing.

2.1 Operation Principles of the Memory Management Device 14

First, the basic operation principles of the memory management device 14 in reading and writing are described, respectively.

2.1.1 Read Operation

In reading, the NAND processing unit 30 first receives a read command and the CPU physical address ADD_{CPU}1 from the processors 11. The NAND processing unit 30 then refers to the address translation table 36 in the storage unit 31 to recognize the NAND physical address ADD_{NAND}1 and the ECC information corresponding to ADD_{CPU}1.

The NAND processing unit 30 transfers ADD_{NAND}1 to the command/address issuing unit 37 of the NAND controller 33, and instructs the command/address issuing unit 37 to issue a read command. Accordingly, the command/address issuing unit 37 outputs a read command and ADD_{NAND}1 to the sequencer of the NAND flash memory 22.

On the basis of the ECC information obtained by reference to the coloring table 35, the NAND processing unit 30 instructs the ECC unit 38 to select a corresponding error correction method. As a result, in the ECC unit 38, a circuit for processing based on the selected error correction method is enabled, and circuits for processing based on other methods are disabled.

In the NAND flash memory 22, page data D_{READ} corresponding to ADD_{NAND}1 is read to the page buffer in response to the read command, and further transferred to the ECC unit 38. The ECC unit 38 then detects and corrects errors in D_{READ} in accordance with the selected error correction method.

2.1.2 Write Operation

In writing, the above-described processing in reading is reversed. That is, the NAND processing unit 30 first receives a write command, data D_{WRITE}, and the CPU physical address ADD_{CPU}2 from the processors 11. The NAND processing unit 30 then refers to the address translation table 36 in the storage unit 31 to recognize the NAND physical address ADD_{NAND}2 and the ECC information corresponding to ADD_{CPU}2.

The NAND processing unit 30 instructs the ECC unit 38 to select a corresponding error correction method in accordance with the ECC information obtained by reference to the coloring table 35. As a result, in the ECC unit 38, a circuit for processing based on the selected error correction method is enabled, and circuits for other methods are disabled.

The ECC unit 38 then generates an error correction code (parity) for the D_{WRITE} in accordance with the selected error correction method, and transfers the data D_{WRITE} and the generated error correction code to the page buffer of the NAND flash memory 22.

The NAND processing unit 30 transfers ADD_{NAND}2 to the command/address issuing unit 37 of the NAND controller 33, and instructs the command/address issuing unit 37 to issue a write command. Accordingly, the command/address issuing unit 37 outputs a write command and ADD_{NAND}2 to the sequencer of the NAND flash memory 22.

In the NAND flash memory 22, the data D_{WRITE} and the error correction code transferred to the page buffer are written to an area corresponding to ADD_{NAND}2 in response to the write command.

2.2 Specific Example of the Operation of the ECC Unit 38

Now, a specific example of the above-mentioned configuration and operation is described below in connection with the ECC unit 38 in particular.

2.2.1 Configuration of the ECC Unit 38

FIG. 6 is a block diagram of the ECC unit 38 according to the present embodiment. Although arrows indicated in FIG. 6 represent the flow of signals in reading, the flow is reversed in writing.

As shown, the ECC unit 38 includes a cyclic redundancy check (CRC) unit 40, a first ECC circuit 41, a second ECC circuit 42, and a selection circuit 43.

In reading, the CRC unit 40 checks inspection data compliant with a CRC method included in data. In writing, the CRC unit 40 generates inspection data compliant with the CRC method for data to be written.

The first ECC circuit 41 is enabled by a signal Enb1, and detects and corrects errors in accordance with a first error correction method. That is, in writing, the first ECC circuit 41 generates a first parity P1 in accordance with the first error correction method. On the other hand, in reading, the first ECC circuit 41 generates a syndrome in accordance with the first error correction method, and detects and corrects errors. The first error correction method has a first error correction capability.

The second ECC circuit 42 is enabled by a signal Enb2, and detects and corrects errors in accordance with a second error correction method. That is, in writing, the second ECC circuit 42 generates a second parity P2 in accordance with the second error correction method. On the other hand, in reading, the second ECC circuit 42 generates a syndrome in accordance with the second error correction method, and detects and corrects errors. The second error correction method has a second error correction capability. Signals Enb1 and Enb2 are provided from, for example, the NAND processing unit 30.

The selection circuit 43 selects the output of the first ECC circuit 41 or the output of the second ECC circuit 42 in accordance with, for example, the instruction of the NAND processing unit 30.

FIG. 7 is a schematic diagram of the page data generated when the first error correction method is selected. As shown, write data (referred to as main data Dmain) provided from the processors 11 (or the volatile semiconductor memory 21) is divided into N data (N is a natural number greater than or equal to 2). The divided N data are referred to as main data D1 to DN, respectively. For the N main data D1 to DN, the first ECC circuit 41 generates the first parity P1 to PN, and the CRC unit 40 generates inspection data CRC1 to CRCN. The main data Di, the first parity Pi, and the inspection data CRCi (i is one of 1 to N) are collectively referred to as an i-th sector.

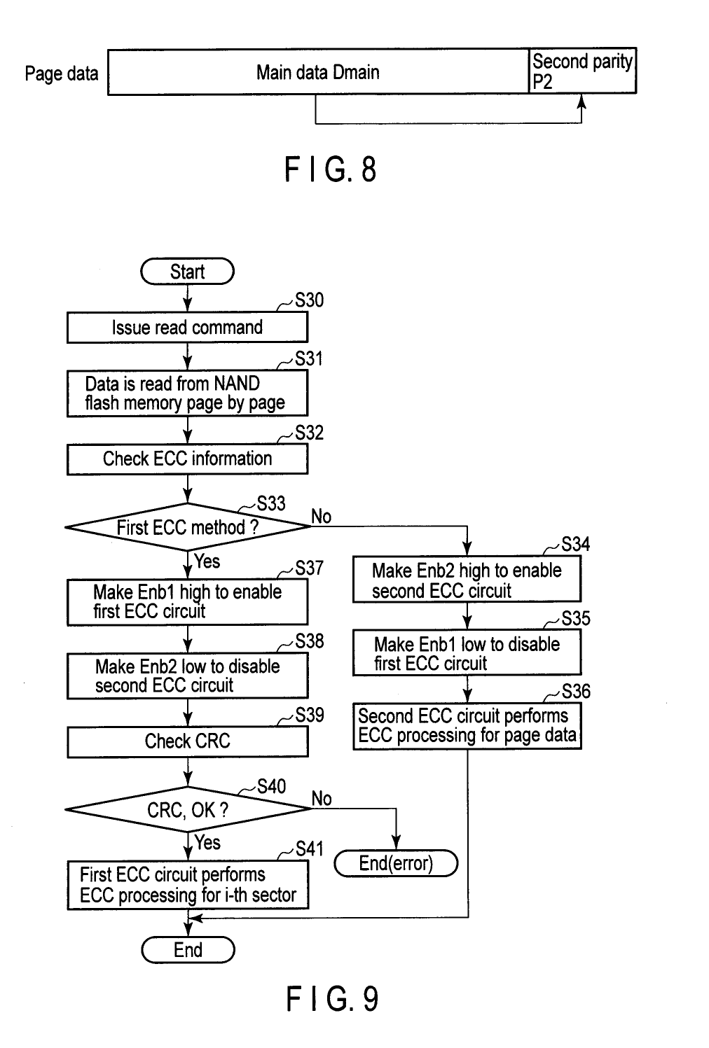

FIG. 8 is a schematic diagram of the page data generated when the second error correction method is selected. As shown, the second ECC circuit 42 generates the second parity P2 for the main data Dmain, and adds the second parity P2 to the end of the main data Dmain.

In the present embodiment, the second error correction method is superior to the first error correction method, and the error correction capability C_error is defined, for example, in the following manner:

C_error=B_error/L_code

L_code=N_main+N_parity

where B_error represents the number of error-correctable bits, L_code represents code length, N_main represents the number of main data bits, and N_parity represents the number of parity bits.

Note that the number of main data bits for the first error correction capability is the number of bits of the main data Di, and the number of main data bits for the second error correction capability is the number of bits of the main data Dmain (the sum of the number of bits of D1 to DN).

Furthermore, as the ECC processing is performed sector by sector in the first error correction method, the scale of the first ECC circuit 41 is smaller than the scale of the second ECC circuit 42. The processing speed of the first ECC circuit 41 is higher than the processing speed of the second ECC circuit 42. Thus, the OS or application applies the first error correction method (the data format shown in FIG. 7) to data that requires high-speed access, and applies the second error correction method (the data format shown in FIG. 8) to data that does not require high-speed access.

2.2.2 Operation of Reading

Now, the operation of reading is described with reference to FIG. 9. FIG. 9 is a flowchart for reading.

As previously described, when the command/address issuing unit 37 issues a read command (step S30), the data D_{READ} is read from the NAND flash memory 22 page by page (step S31). The data D_{READ} has the structure shown in FIG. 7 when the first error correction method is used. The data D_{READ} has the structure shown in FIG. 8 when the second error correction method is used.

The NAND processing unit 30 refers to the coloring table 35 to check the ECC information regarding the data D_{READ} (step S32). If the first error correction method is not used, that is, if the second error correction method is used (step S33, NO), the NAND processing unit 30 makes signal Enb2 high to enable the second ECC circuit 42 (step S34). The NAND processing unit 30 also makes signal Enb1 low to disable the first ECC circuit 41 (step S35). The second ECC circuit 42 then uses the second parity P2 in the data D_{READ} to perform the ECC processing (step S36). Further, the selection circuit 43 selects data processed by the second ECC circuit 42, and outputs the data to the processors 11 and/or the volatile semiconductor memory 21.

On the other hand, when the first error correction method is used in step S32 (step S33, YES), the NAND processing unit 30 makes signal Enb1 high to enable the first ECC circuit 41 (step S37). The NAND processing unit 30 also makes signal Enb2 low to disable the second ECC circuit 42 (step S38). The CRC unit 40 then checks the inspection data CRCi (step S39). If no error is detected as a result of step S39 (step S40, YES), the first ECC circuit 41 performs the ECC processing for the i-th sector (step S41). The selection circuit 43 selects the data processed by the first ECC circuit 41, and outputs the data to the processors 11 and/or the volatile semiconductor memory 21. The processing in steps S39 to S41 is sequentially performed for all of the first to N-th sectors. However, when a CRC error occurs (step S40, NO), the reading results in an error, and the processing ends.

2.2.3 Operation of Writing

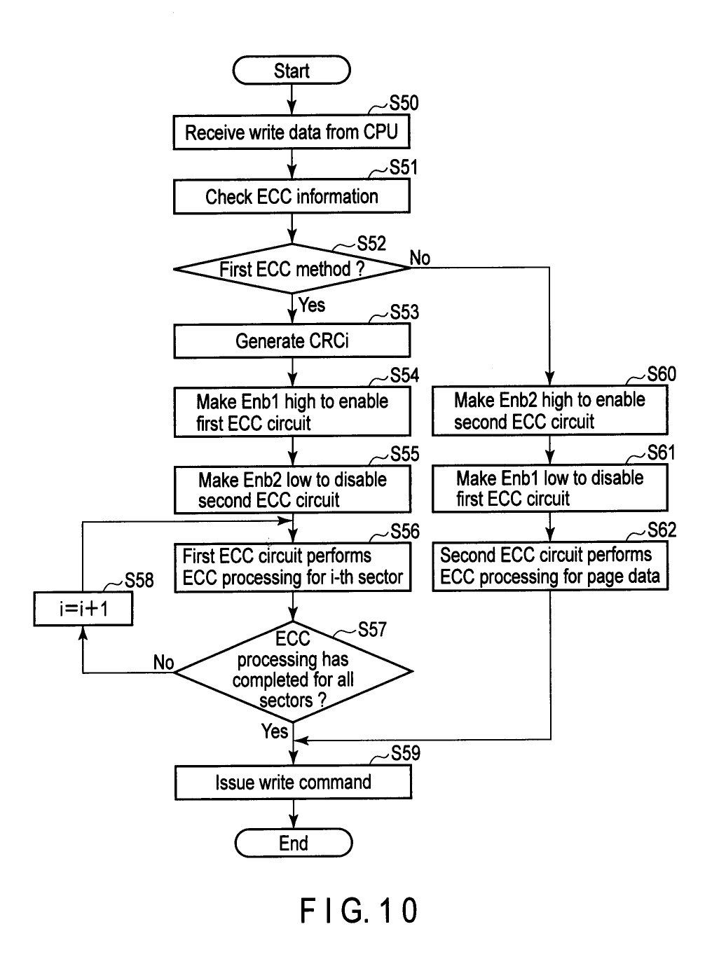

Now, the operation of writing is described with reference to FIG. 10. FIG. 10 is a flowchart for writing.

As previously described, the memory management device 14 receives the write data D_{WRITE} from the processors 11 (step S50). The data D_{WRITE} corresponds to a set of the main data D1 to DN in FIG. 7, namely, the main data Dmain in FIG. 8.

The NAND processing unit 30 refers to the coloring table 35 to check the ECC information regarding the data D_{WRITE} (step S51). If the first error correction method is used (step S52, YES), the CRC unit 40 generates the inspection data CRCi for the main data Di (step S53). The initial value of i is “1”. Further, the NAND processing unit 30 makes signal Enb1 high to enable the first ECC circuit 41 (step S54). The NAND processing unit 30 also makes signal Enb2 low to disable the second ECC circuit 42 (step S55). The first ECC circuit 41 performs the ECC processing for the i-th sector (step S56). That is, the first ECC circuit 41 generates a first parity P1-i by using the main data Di. As a result, the i-th sector is completed. The above-described processing is repeated for all the sectors (step S57, NO, step S58).

Consequently, the data having the structure shown in FIG. 7 is completed, and transferred to the page buffer of the NAND flash memory 22. The command/address issuing unit 37 then issues a write command (step S59).

On the other hand, when the second error correction method is selected in step S52 (step S52, NO), the NAND processing unit 30 makes signal Enb2 high to enable the second ECC circuit 42 (step S60). The NAND processing unit 30 also makes signal Enb1 low to disable the first ECC circuit 41 (step S61). The second ECC circuit 42 performs the ECC processing for the data D_{WRITE} (main data Dmain) to generate the second parity P2 (step S62). As a result, the data having the structure shown in FIG. 8 is completed. This data is transferred to the page buffer of the NAND flash memory 22, and a write command is issued (step S59).

3. Advantage According to the Present Embodiment

As described above, power consumption can be reduced in the semiconductor device according to the present embodiment. Such an advantage is described below.

The memory management device 14 according to the present embodiment has the ECC information as the coloring information. The ECC information is information indicating an error correction method that is applied or that is to be applied for each data. When there is a request to access data, the memory management device 14 only activates the necessary ECC circuit on the basis of the ECC information. This makes it possible to minimize the operation of the ECC circuit and reduce power consumption.

More specifically, the configuration according to the present embodiment supports the first error correction method, and the second error correction method which is lower in speed than the first error correction method but has a high correction capability. The first error correction method is applied to data that requires high-speed access, and the second error correction method is applied to data that is satisfied low-speed access. Such information is registered in the address translation table as the ECC information.

Thus, when data that requires high-speed access is accessed, the NAND processing unit 30 activates the first ECC circuit 41 that performs the ECC processing compliant with the first error correction method on the basis of the ECC information. In this case, the second ECC circuit 42 that performs the ECC processing compliant with the second error correction method is not activated.

On the other hand, when data that only requires low-speed access is accessed, the NAND processing unit 30 activates the second ECC circuit 42 and does not activate the first ECC circuit 41 on the basis of the ECC information.

Thus, one of the first and second ECC circuits 41 and 42 that is necessary is only activated, and both the circuits are not activated at the same time. This makes it possible to reduce power consumption in the ECC unit 38, and ensure error correction, and at the same time, satisfy the requirement for the speed of access by the processors 11.

The first error correction method according to the present embodiment enables faster data access. This is described below.

In the NAND flash memory, an area at the end of a memory cell array is generally used as an area for ECC data. Therefore, as shown in FIG. 8, in the data structure of one page, the main data is first located from a low column address area, and the parity is collectively located after the main data.

In reading, when a bus width between the page buffer and the ECC unit is smaller than the page size, data is transferred to the ECC unit on a bus width basis in the order of column addresses. Therefore, the ECC unit cannot start the ECC processing until all the main data is transferred to the ECC unit and the transfer of the parity to the ECC unit is further completed.

In contrast, the first ECC circuit 41 according to the present embodiment performs the ECC processing sector by sector as has been described with reference to FIG. 7. More specifically, the main data to be written to one page is divided into N groups, and a first parity P1-i is generated for each group. The first parity P1-i is placed immediately after the main data Di used to generate the first parity P1-i.

That is, the data structure in one page has an array of main data D1/parity P1-1/main data D2/parity P1-2/ . . . in ascending order of the column addresses. Thus, the first ECC circuit 41 of the ECC unit 38 can start the ECC processing for the first sector on receipt of the main data D1 and the parity P1-1 without waiting for data of the second and subsequent sectors to be received. The same applies to the subsequent sectors.

Thus, the ECC processing is sequentially performed sector by sector, and data can be supplied to the processors 11 and/or the volatile semiconductor memory 21 in order from the sector that has finished with the ECC processing. Therefore, the processors 11 can access data at high speed. This can be said to be more advantageous in an embodiment in which the NAND flash memory 22 is used as the main memory.

The NAND processing unit 30 calculates a page number and a sector number from the NAND physical address, and further calculates a column address in the page. In this case, the data format shown in FIG. 7 and the data format shown in FIG. 8 are different in the way of calculating the position of effective data in the page.

If the NAND physical addresses are allocated page by page, the calculations in the case of the data format shown in FIG. 7 are as follows:

Page number=int(NAND physical address/number of data/number of sectors)

Sector number=int(NAND physical address/number of data)mod number of sectors

Column address=(number of data+number of parities+number of CRCs)×sector number

where the number of data, the number of parities, and the number of CRCs are the number of bits of the main data Di in each sector, the number of bits of the first parity P1-i, and the number of bits of the inspection data CRCi, respectively, and are, for example, 128 bytes, 4 bytes, and 1 byte, respectively. In above formula, int (A) acquires the integral part of A, and AmodB indicates a calculation for acquiring the remainder when A is divided by B.

The calculations in the case of the data format shown in FIG. 8 are as follows:

Page number=int(NAND physical address/number of data)

Column address=0

In this case, for example, the number of data is 1024 bytes, and the number of parities (the number of bits of the second parity P2) is 42 bytes.

### Second Embodiment

Now, a semiconductor device according to the second embodiment is described. The present embodiment concerns another specific example of the ECC unit 38 described with reference to FIG. 7 to FIG. 10 in the first embodiment. The differences between the second embodiment and the first embodiment are only described below.

1. Configuration of the ECC Unit 38

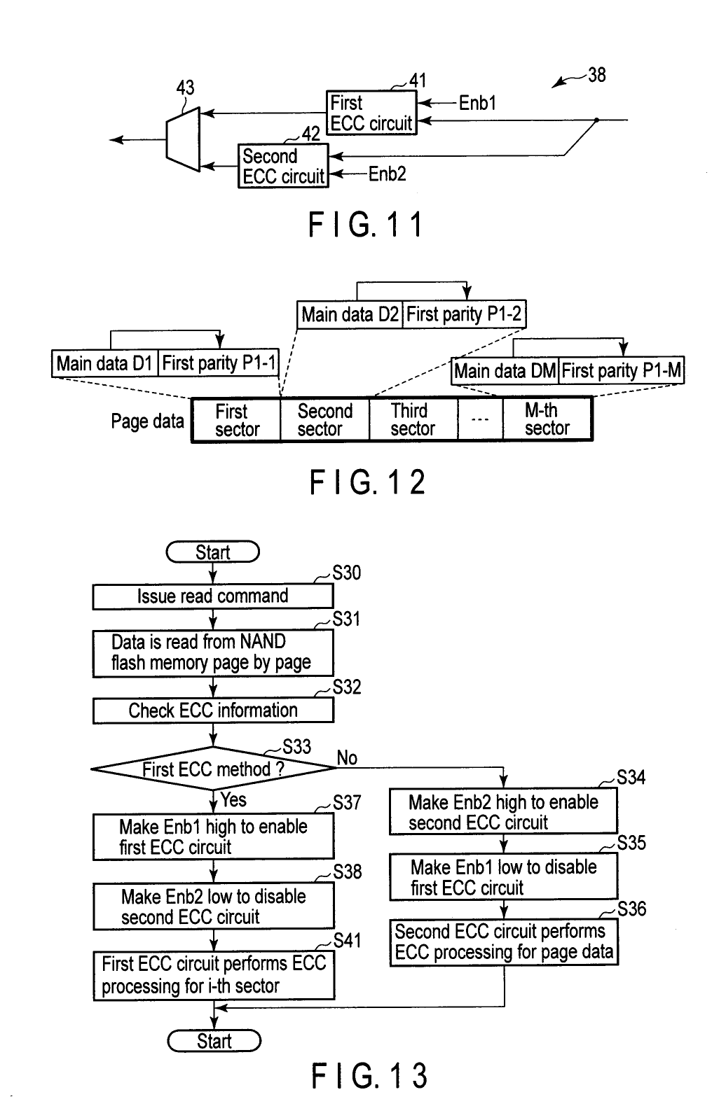

FIG. 11 is a block diagram of the ECC unit 38 according to the present embodiment. Although arrows indicated in FIG. 11 represent the flow of signals in reading, the flow is reversed in writing.

As shown, the configuration of the ECC unit 38 according to the present embodiment is equivalent to the configuration shown in FIG. 6 described in the first embodiment from which the CRC unit is eliminated, and is similar to the configuration according to the first embodiment in other respects. In the present embodiment, the second error correction capability is equal to or superior to the first error correction capability. As in the first embodiment, the processing speed of the first ECC circuit 41 is higher than the processing speed of the second ECC circuit 42. On the other hand, the scale of the second ECC circuit 42 is smaller than the scale of the first ECC circuit 41, and a coding ratio R2 of the second ECC circuit 42 is superior to a coding ratio R1 of the first ECC circuit 41. That is, R1<R2. The coding ratio means the ratio between input data and output data (input data with a parity). The coding ratio is B1/(B1+B2) where B1 is the number of bits of the input data and B2 is the number of bits of the parity. Therefore, the OS or application applies the first error correction method to data that requires high-speed access, and applies the second error correction method to data that does not require high-speed access.

FIG. 12 is a schematic diagram of page data generated when the first error correction method is selected. As shown, the configuration according to the present embodiment is equivalent to the configuration shown in FIG. 7 described in the first embodiment in which the CRC is eliminated from each sector. The number of sectors M (M is a natural number greater than or equal to 2) may be equal to or different from N.

Page data generated when the second error correction method is selected is the same as that described in the first embodiment.

2. Operation According to the Present Embodiment

2.1 Operation of Reading

Now, the operation of reading is described with reference to FIG. 13. FIG. 13 is a flowchart for reading.

As shown, the operation according to the present embodiment is equivalent to the operation shown in FIG. 9 described in the first embodiment from which the processing associated with the CRC (steps S39 and S40) is eliminated.

2.2 Operation of Writing

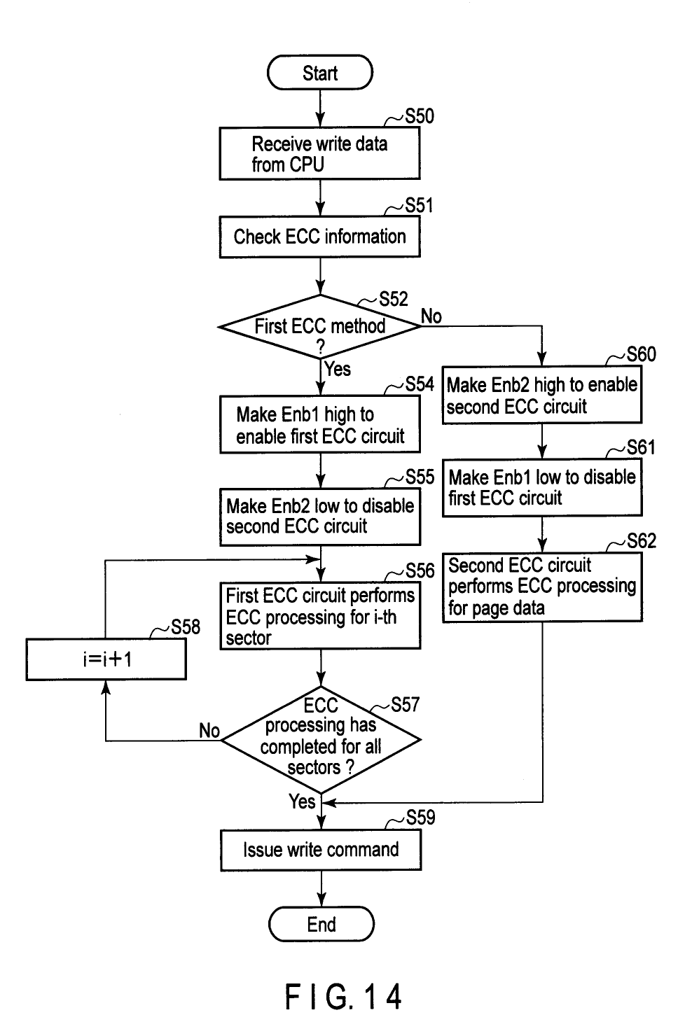

Now, the operation of writing is described with reference to FIG. 14. FIG. 14 is a flowchart for writing.

As shown, the operation according to the present embodiment is equivalent to the operation shown in FIG. 10 described in the first embodiment from which the processing associated with the CRC (step S53) is eliminated.

3. Advantage According to the Present Embodiment

As described above, the second embodiment can also be applied to the case where the error correction methods have the same error correction capability, and provide an advantage similar to that in the first embodiment.

### Third Embodiment

Now, a semiconductor device according to the third embodiment is described. The present embodiment is a combination of the specific example of the ECC unit 38 described in the first embodiment and the specific example of the ECC unit 38 described in the second embodiment. That is, this is a case where the page data can adopt three formats: the formats shown in FIG. 7 and FIG. 8 described in the first embodiment, and the format shown in FIG. 12 described in the second embodiment. The differences between the third embodiment and the first and second embodiments are only described below.

1. Configuration of the ECC Unit 38

In the present embodiment, the formats shown in FIG. 7, FIG. 8, and FIG. 12 are respectively referred to as first to third formats, and such information is held in the coloring table 35 as ECC information.

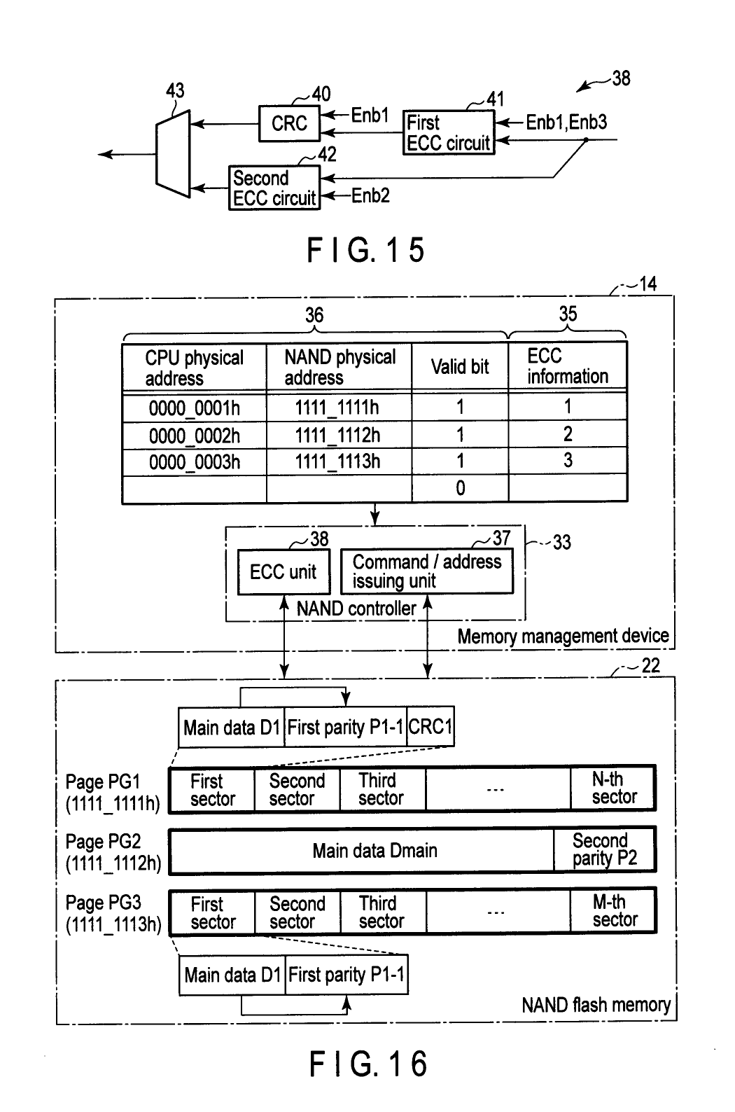

FIG. 15 is a block diagram of the ECC unit 38 according to the present embodiment. As shown, the block configuration of the ECC unit 38 is the same as that in FIG. 6 described in the first embodiment.

However, the CRC unit 40 is enabled when signal Enb1 is high. On the other hand, when signal Enb1 is low, the CRC unit 40 is disabled and outputs an input signal as it is. The first ECC circuit 41 is also enabled when a signal Enb3 is high.

When the first format is selected, signal Enb1 is made high, signal Enb2 is made low, and signal Enb3 is made low. That is, in this case, the ECC unit 38 performs the same operation as the operation performed when the first error correction method is selected in the first embodiment.

When the second format is selected, signal Enb1 is made low, signal Enb2 is made high, and signal Enb3 is made low. That is, in this case, the ECC unit 38 performs the same operation as the operation performed when the second error correction method is selected in the first embodiment.

When the third format is selected, signal Enb1 is made low, signal Enb2 is made low, and signal Enb3 is made high. That is, in this case, the ECC unit 38 performs the same operation as the operation performed when the first error correction method is selected in the second embodiment.

2. Specific Example

FIG. 16 is a schematic diagram only showing by way of example principal parts of the memory management device 14 and the NAND flash memory 22 according to the present embodiment.

As shown, data in the first to third formats are written in pages PG1 to PG3 of the NAND flash memory 22, respectively. NAND physical addresses of pages PG1 to PG3 are (1111_{—}1111h), (1111_{—}1112h), and (1111_{—}1113h). “h” at the end of the numbers indicating the address means that the eight-digit number before “h” is a hexadecimal number.

Three CPU physical addresses (0000_{—}0001h), (0000_{—}0002h), and (0000_{—}0003h) are registered in the address translation table 36 of the memory management device 14. The NAND physical addresses (1111_{—}1111h), (1111_{—}1112h), and (1111_{—}1113h) are associated with the CPU physical addresses, respectively. Thus, a value “1” indicating the first format, a value “2” indicating the second format, and a value “3” indicating the third format are allocated as ECC information to entries corresponding to the CPU physical addresses in the coloring table 35.

For example, when there is a read access from the processors 11 using the CPU physical address (0000_{—}0001h), the memory management device 14 reads the corresponding page PG1. The ECC unit 38 then performs ECC processing for the first format (i.e., processing performed when the first error correction method is selected in the first embodiment) on the basis of the ECC information=“1”.

When there is a read access using the CPU physical address (0000_{—}0002h), the memory management device 14 reads the corresponding page PG2. The ECC unit 38 then performs ECC processing for the second format on the basis of the ECC information=“2”.

When there is a read access using the CPU physical address (0000_{—}0003h), the memory management device 14 reads the corresponding page PG3. The ECC unit 38 then performs ECC processing for the third format on the basis of the ECC information=“3”.

3. Advantage According to the Present Embodiment

As described above, the first embodiment and the second embodiment can be implemented together.

### Fourth Embodiment

Now, a semiconductor device according to the fourth embodiment is described. The present embodiment uses ECC information for the wear leveling or the garbage collection in the first embodiment. What has not been described in the first embodiment and the differences between the fourth embodiment and the first embodiment are only described below.

1. Configuration According to the Present Embodiment

1.1 Configuration of the NAND Flash Memory

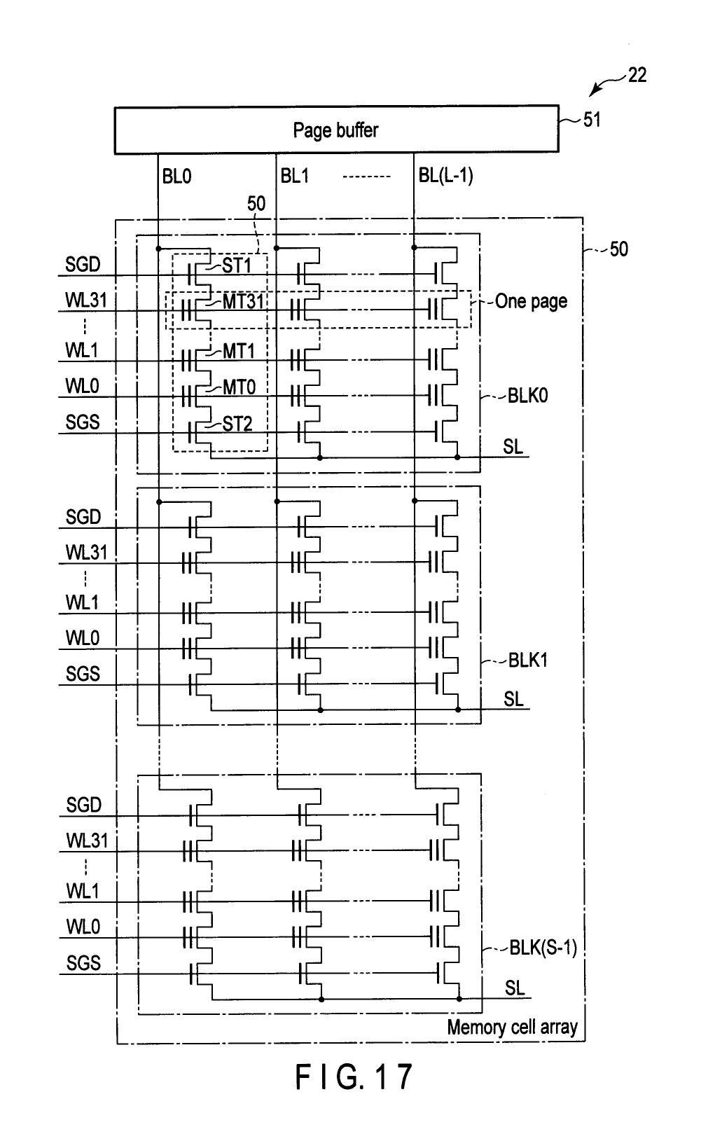

FIG. 17 is a block diagram showing configuration of the NAND flash memory 22. As shown, the NAND flash memory 22 includes a memory cell array 50 and a page buffer 51.

First, the memory cell array 50 is described. As shown, the memory cell array 50 includes S (S is a natural number greater than or equal to 2) memory blocks BLK (BLK0 to BLK(S−1)). Each of the memory blocks BLK includes L (L is a natural number greater than or equal to 2) NAND cells 53. Each of the NAND cells 53 includes, for example, 32 memory cell transistors MT (MT0 to MT31), and select transistors ST1 and ST2. Each of the memory cell transistors MT includes a stack gate structure including a charge accumulation layer (e.g., a floating gate) formed on a semiconductor substrate with a gate insulating film interposed therebetween, and a control gate formed on the charge storage layer with an inter-gate insulating film interposed therebetween. The number of the memory cell transistors MT is not exclusively 32, and may be, for example, 8, 16, 64, 128 or 256. The memory cell transistors MT are arranged between the select transistors ST1 and ST2 so that their current paths are connected in series. A drain at one end of the memory cell transistors MT connected in series is connected to a source of the select transistor ST1, and a source at the other end is connected to a drain of the select transistor ST2.

Control gates of the memory cell transistors MT in the same row are connected to a common word line WL (WL0 to WL31), and gates of the select transistors ST1 and ST2 of the memory cells in the same row are connected to common select gate lines SGD and SGS, respectively.

In the memory cell array 50, the memory blocks BLK are arranged in a direction perpendicular to the word lines WL. Drains of the select transistors ST1 in the same row are connected to a common bit line BL (BL0 to BL(L−1)). Sources of the select transistors ST2 are connected to a common source line SL.

In the configuration described above, data in NAND cells 23 in the same memory block BLK are collectively erased. Data is collectively written to or read from the memory cell transistors MT connected to the same word line WL, and this unit is a page. Thus, as the number of word lines in each block BLK is 32 in the SLC NAND flash memory, the number of pages in each block BLK is also 32.

On the other hand, in the MLC NAND flash memory, a page is allocated to each of the multiple bits held by each of the memory cell transistors MT. That is, data is written or read bit by bit. Therefore, for example, when each of the memory cell transistors MT holds 2-bit data, the number of pages in each block BLK is (32×2)=64. When each of the memory cell transistors MT holds 3-bit data, the number of pages in each block BLK is (32×3)=96, and so fourth.

In writing, the page buffer 51 holds write data received from the memory management device 14, and transfers the write data to each bit line BL to write the data to the memory cell transistors MT. In reading, the page buffer 51 senses and amplifies data read onto each bit line BL, and then transfers the data to the memory management device 14.

1.2 Address Translation Table 36

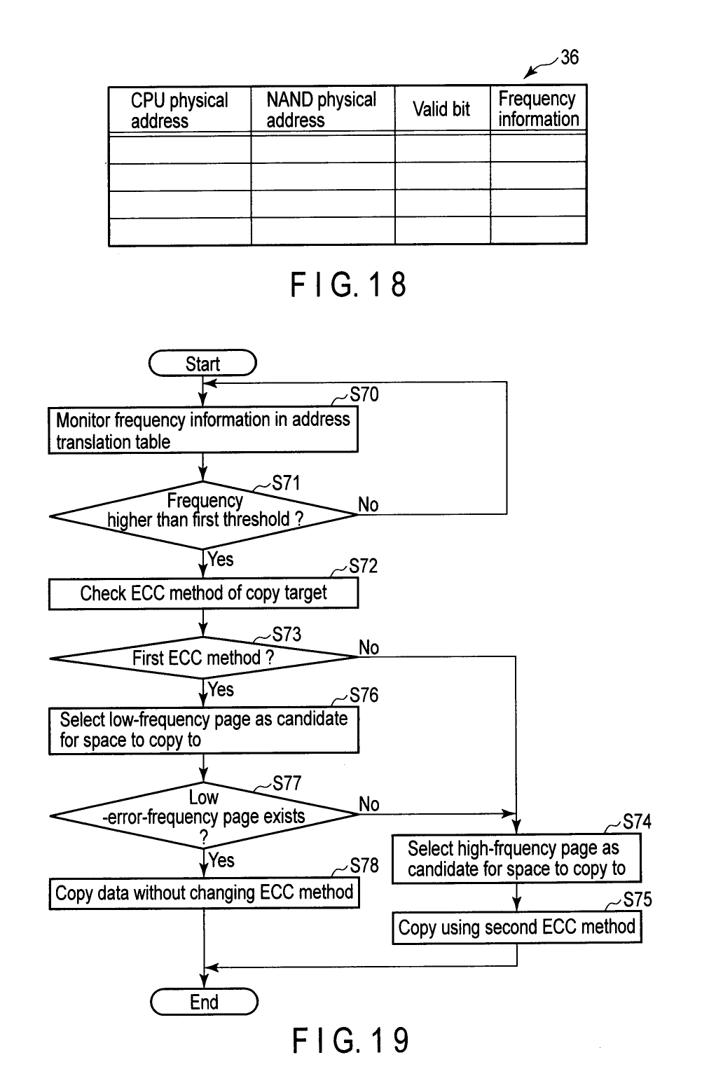

Now, the address translation table 36 according to the present embodiment is described with reference to FIG. 18. FIG. 18 is a schematic diagram showing the address translation table 36 according to the present embodiment.

As shown, the address translation table 36 has the configuration shown in FIG. 5 described in the first embodiment which further includes a frequency information field. The frequency information field stores frequency information that indicates the frequency of errors in a corresponding CPU physical address. This frequency information is created and updated by the NAND processing unit 30 in accordance with, for example, the result of error correction in the ECC unit 38. A specific example of the error frequency is a cumulative value of the number of error bits generated in reading the data, a cumulative number of occurrences of errors, or a cumulative number of erases of a corresponding page.

1.3 Wear Leveling and Garbage Collection

Now, the wear leveling and the garbage collection are briefly described.

The wear leveling is processing for managing the number of rewritings for each memory block BLK to prevent the concentration of data accesses to a particular memory block BLK.

For example, when data is written to a memory block BLK1, the data is written to another memory block BLK2 having a lower write frequency if the write frequency of memory block BLK1 is high, and data already written to memory block BLK1 is copied to memory block BLK2. This is the wear leveling. The wear leveling does not necessarily have to be performed at the time of writing. When the write frequency of a memory block BLK1 is higher than a given threshold, the whole memory block BLK1 may be copied to another memory block BLK2 in accordance with given timing.

The garbage collection is a method of copying effective data in several memory blocks BLK having reduced effective data to another erased memory block BLK and erasing the original memory blocks BLK to use these memory blocks BLK as erased memory blocks BLK.

In the NAND flash memory 22, data is written in order from word line WL0 close to the select gate line SGS. That is, data is permitted to be only written once, and overwriting of data is prohibited.

Therefore, for example, when data on word line WL0 of memory block BLK0 is updated, the data on word line WL0 of memory block BLK0 is kept unchanged, and updated data is written to, for example, the word line WL of any one of erased memory blocks BLK1. In this case, data remaining on word line WL0 of memory block BLK0 is ineffective data.

If the number of updating the data increases, the erased memory blocks BLK eventually run out, and writing becomes impossible. The garbage collection solves this problem.

That is, for example, in FIG. 17, data on word lines WL0 to WL15 have already been updated in memory blocks BLK0 and BLK1 (updated data is written in another memory block BLK), and data on word lines WL16 to WL31 are effective data. Moreover, memory block BLK(S−1) is erased.

In this case, the data on word lines WL16 to WL31 in memory blocks BLK0 and BLK1 are copied to word lines WL0 to WL31 of memory block BLK(S−1). Memory blocks BLK0 and BLK1 are then erased. As a result, two erased blocks (BLK0 and BLK1) can be newly secured.

The wear leveling and the garbage collection described above are controlled by the NAND processing unit 30. In this case, the NAND processing unit 30 selects a space to copy to in accordance with an applied error correction method. This operation is described below.

2. Operation According to the Present Embodiment

2.1 Operation in the Wear Leveling and the Garbage Collection

Now, the operation of the memory management device 14 according to the present embodiment during the wear leveling and the garbage collection is described with reference to FIG. 19. FIG. 19 is a flowchart showing the operation of the memory management device 14.

As shown, the NAND processing unit 30 monitors the frequency information in the address translation table 36 constantly or periodically or in a free time in which the NAND processing unit 30 performs no processing (step S70). The NAND processing unit 30 then determines whether the error frequency of each entry of the address translation table 36 is higher than a first threshold Fth1. The first threshold Fth1 is set, for example, for each entry (i.e., for each CPU physical address, or for each page), and this information is provided to the NAND processing unit 30 by, for example, the OS.

When the error frequency is higher than the first threshold Fth1 in any one of the entries (step S71, YES), the NAND processing unit 30 decides to move the data corresponding to this entry to another page. The NAND processing unit 30 then refers to the ECC information corresponding to this entry in the coloring table 35 to check the currently applied error correction method (step S72).

When it is found out in step S72 that the second error correction method is applied, that is, when a method having a high error correction capability is applied (step S73, NO), the NAND processing unit 30 selects a page having a high error frequency as a candidate for a space to copy to (step S74). In this case, the error frequency is determined by, for example, a second threshold Fth2. For example, Fth2≦Fth1.

The NAND processing unit 30 then instructs the NAND controller 33 to copy the data to a free page having a high error frequency without changing the error correction method (step S75). As a result, in the NAND flash memory 22, data corresponding to the relevant entry is read to the page buffer 51, and this data is further copied to the free page.

When there is only a free page having a low error frequency, the data is copied to this free page.

When it is found out in step S72 that the first error correction method is applied, that is, when a method having a low error correction capability is applied (step S73, YES), the NAND processing unit 30 selects a page having a low error frequency as a candidate for a space to copy to (step S76). Thus, the NAND processing unit 30 refers to the address translation table 36 to determine whether there is a free page having a low error frequency.

If there is a free page having a low error frequency (step S77, YES), the NAND processing unit 30 instructs the NAND controller 33 to copy the data to this free page without changing the error correction method (step S78). As a result, in the NAND flash memory 22, data corresponding to the relevant entry is read to the page buffer 51, and this data is further copied to the free page.

If there is no free page having a low error frequency (step S77, NO), the NAND processing unit 30 instructs the NAND controller 33 to changes the error correction method to the second error correction method, and then to copy the data to a free page having a high error frequency (steps S74 and S75). As a result, data corresponding to the relevant entry is read to the page buffer 51, and this data is further transferred to the ECC unit 38. The ECC unit 38 detects and corrects errors. The ECC unit 38 then performs the ECC processing in accordance with the second error correction method to generate a second parity P2, and transfers data including the second parity P2 to the page buffer 51. This data is then copied to a free page.

2.2 Specific Example of the Operation

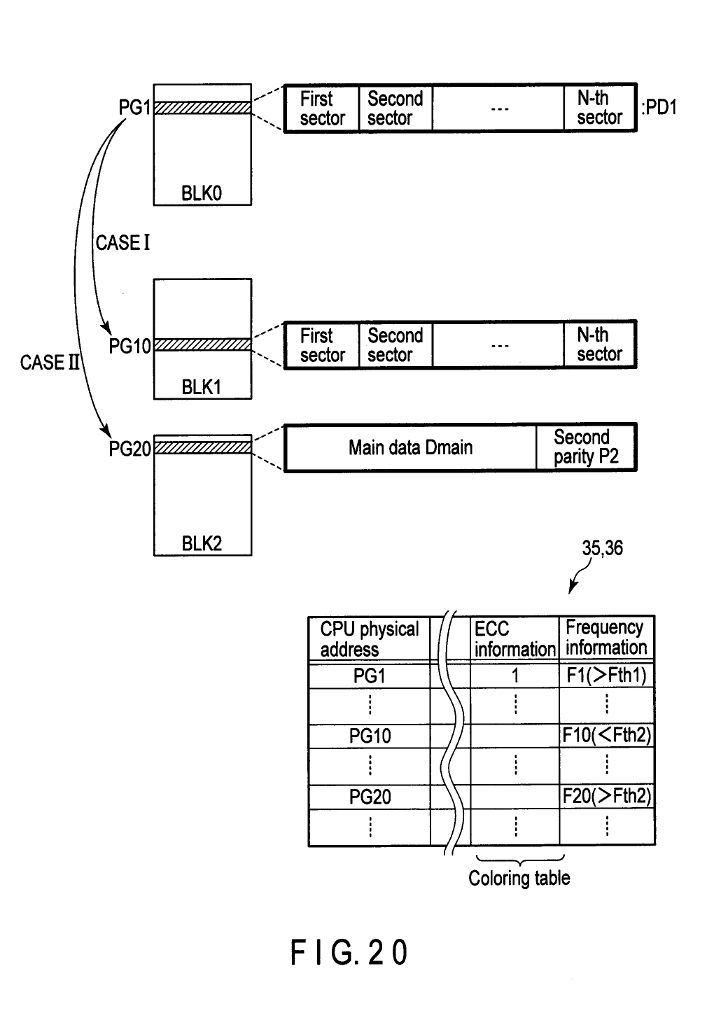

Now, a specific example of the above-mentioned operation is described with reference to FIG. 20. FIG. 20 is a conceptual diagram showing the memory blocks BLK and page data as well as the coloring table 35 and the address translation table 36, and schematically showing how data is copied.

As shown, data PD1 to which the first error correction method is applied is stored in page PG1 of memory block BLK0. The cases where the error frequency F1 of the data PD1 is beyond the first threshold Fth1 and the data is copied to a free page PG10 or PG20 are described below as CASE I and CASE II, respectively.

(CASE I)

First, the first error correction method is applied to the data PD1 to be copied (step S73 in FIG. 19, YES). Accordingly, the NAND processing unit 30 selects a page the error frequency of which is not higher than the second threshold Fth2 as a candidate for a space to copy to (step S76).

In CASE I, page PG10 is a free page, and its error frequency F10 is less than the second threshold Fth2 (see the address translation table 36). Therefore, the NAND processing unit 30 copies the data PD1 to page PG10 as it is (step S78).

(CASE II)

CASE II is described next. CASE II corresponds to the case where page PG10 is in use, page PG20 is a free page, and its error frequency F20 is higher than or equal to the second threshold Fth2 (step S77, NO).

In this case, the NAND processing unit 30 copies the data D1 to page PG20. In this case, the NAND processing unit 30 changes the error correction method from the first error correction method to the second error correction method (step S75).

3. Advantage According to the Present Embodiment

The advantage provided by the configuration according to the present embodiment is that the decrease of the data access speed can be effectively inhibited, in addition to the advantage described in the first embodiment. This advantage is described below.

As has been described in the first embodiment, the first error correction method is applied to data that requires high-speed access, and the second error correction method to data that does not require high-speed access. This relation is desirably maintained even after the wear leveling and the garbage collection.

In this connection, according to the present embodiment, during the wear leveling and the garbage collection, a space to copy to is determined by the error correction method applied to the data to be copied. More specifically, when data adapted to the first error correction method is copied, a page having a low error frequency is selected as a page to copy to. Thus, even after the copying, the first error correction method is applied to enable high-speed access. At the same time, the space to copy to is the page having a low error frequency, so that even the first error correction method can sufficiently correct errors.

On the other hand, when data adapted to the second error correction method is copied, a page having a high error frequency is selected as a page to copy to. This makes it possible to inhibit wasteful use of free pages having a low error frequency. That is, a free page having a low error frequency can be effectively used for the first error correction method. The second error correction method has a high error correction capability, and can therefore sufficiently correct errors even if the space to copy to has a high error frequency.

When there is no free page having a low error frequency, a page having a high error frequency is selected as a page to copy to even if the data to be copied is data adapted to the first error correction method. In this case, the NAND processing unit 30 changes the error correction method from the first error correction method to the second error correction method, and then copies the data. As a result, errors can be sufficiently corrected even after the copying.

### First Modification of the Present Embodiment

In CASE II described with reference to FIG. 20, the data D1 may be again written to memory block BLK0 without being copied to another memory block BLK2.

That is, when determining that there is no free page having a low error frequency (step S77 in FIG. 19, NO), the NAND processing unit 30 only reads the data PD1 or reads all the effective data in memory block BLK0, and causes the data to be temporarily held in, for example, the volatile semiconductor memory 21. The NAND processing unit 30 then erases memory block BLK0. The NAND processing unit 30 then copies the data held in the volatile semiconductor memory 21 to the erased memory block BLK0. In this case, the second error correction method is applied to the data PD1, and the data PD1 is written to memory block BLK0 (step S75).

Thus, there is no particular limit to the space to copy to when the error correction method is changed from the first error correction method to the second error correction method. Therefore, memory block BLK0 in which the data PD1 is originally held may be used as the space to copy to. This can be applied to, for example, the case where there is no free page (space that can be used to copy data to) in step S75 in FIG. 19.

### Second Modification of the Present Embodiment

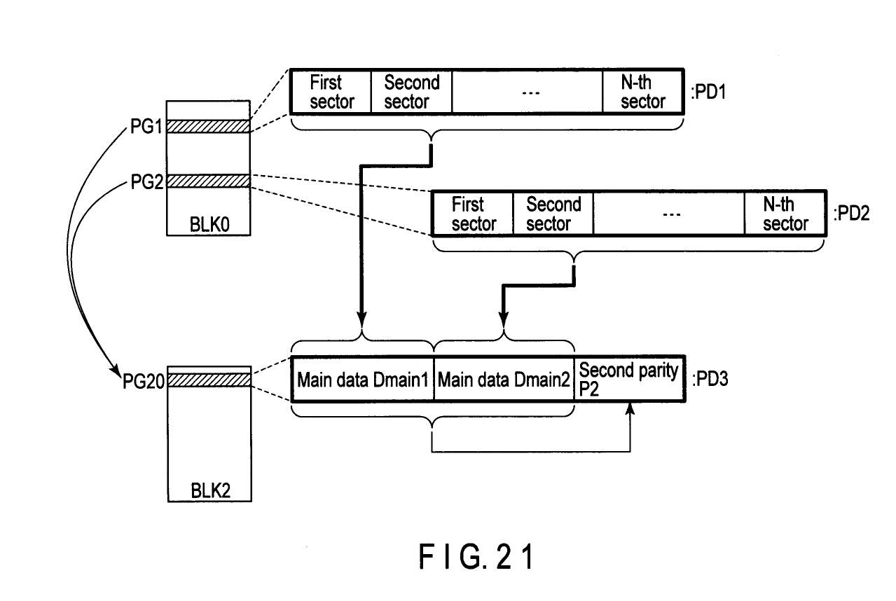

In CASE II described with reference to FIG. 20, pages may be united to one page when data is written to page PG20. Such an example is shown in FIG. 21.

As shown, the data PD1 and PD2 that need to be copied are present in two pages PG1 and PG2, and the first error correction method is applied to both the data PD1 and PD2. In this case, main data Dmain1 (D1 to DN) for a page P1 and main data Dmain2 (D1 to DN) for a page P2 are combined into one data Dmain3. Further, a second parity P2 is generated for the data Dmain3, and data PD3 including the main data Dmain3 and the second parity P2 may be written to page PG20.

That is, the number of bits of the parities included in one page is considerably reduced by changing the error correction method from the first error correction method to the second error correction method. Thus, data can be efficiently stored by storing main data of another page in a free space made by the reduction of the number of bits of the parities.

Therefore, this modification is possible when all of the following conditions are satisfied:
there are two or more pages to be copy to,
at the time of copying, the error correction method is changed to an error correction method lower in error correction capability than the original error correction method (i.e., the number of bits of the parities is reduced by copying), and
the total of the sum of main data of pages to be combined and their parities is less than or equal to the page size.

### Fifth Embodiment

Now, a semiconductor device according to the fifth embodiment is described. In the present embodiment, the function of the memory management device 14 described in the first to fourth embodiments is applied to a solid state drive (SSD).

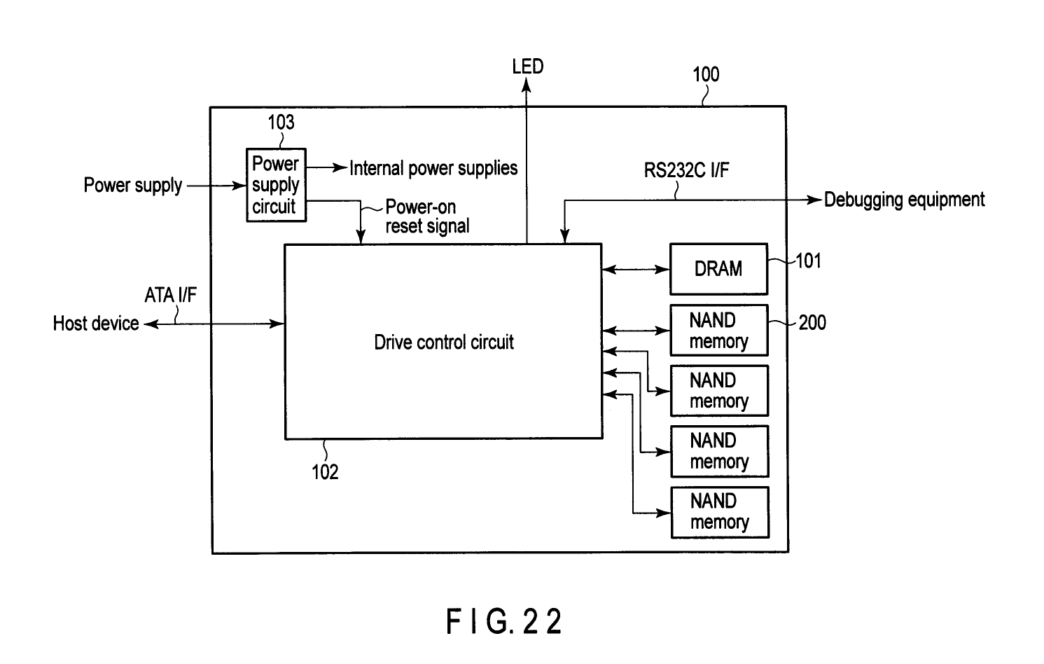

FIG. 22 is a block diagram showing the configuration of an SSD 100. As shown, the SSD 100 includes NAND flash memories 200 for storing data, a DRAM 101 for data transfer or for use as a work space, a drive control circuit 102 for controlling the above components, and a power supply circuit 103. The drive control circuit 102 outputs a control signal for controlling a status display LED provided outside the SSD 100. A ferroelectric random access memory (FeRAM) may be used instead of the DRAM 101.

The SSD 100 sends/receives data to/from a host device such as a personal computer via an ATA interface. The SSD 100 sends/receives data to/from debugging equipment via an RS232C interface.

The power supply circuit 103 receives an external power supply, and uses this external power supply to generate internal power supplies. These internal power supplies are supplied to each component in the SSD 100. The power supply circuit 103 detects the rise of the external power supply, and generates a power-on reset signal. The power-on reset signal is sent to the drive control circuit 102.

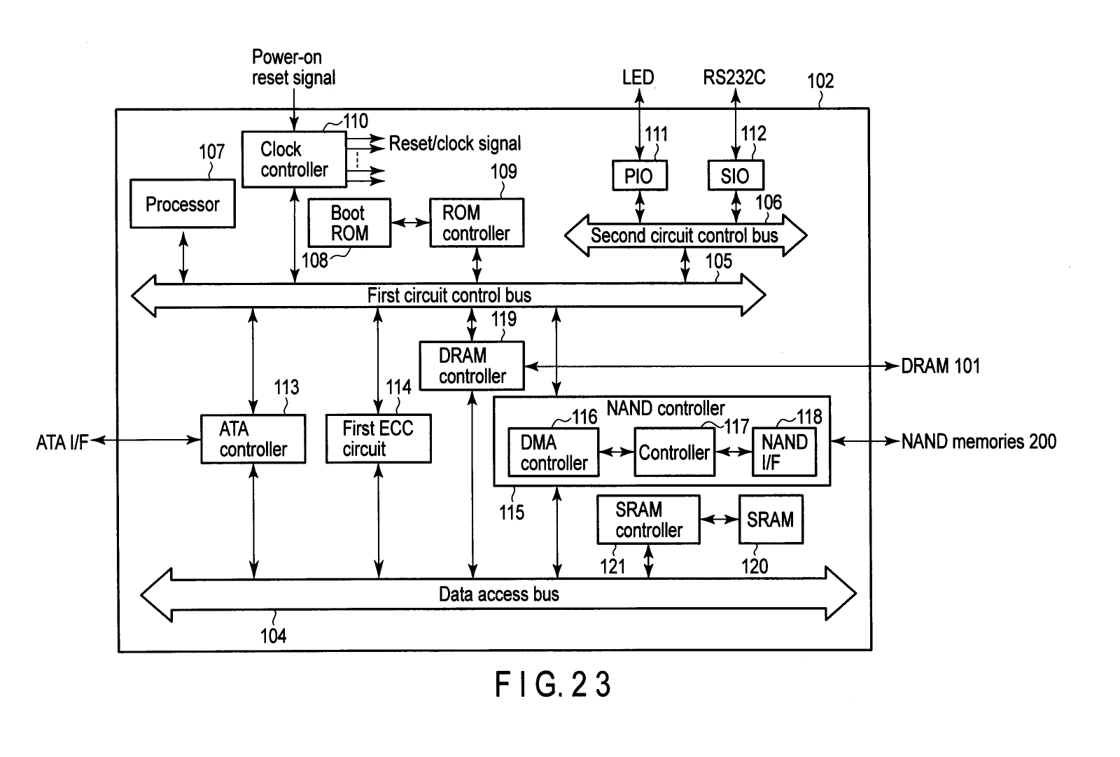

FIG. 23 is a block diagram showing the configuration of the drive control circuit 102. The drive control circuit 102 includes a data access bus 104, a first circuit control bus 105, and a second circuit control bus 106.

A processor 107 for controlling the entire drive control circuit 102 is connected to the first circuit control bus 105. A boot ROM 108 in which boot programs for management programs (FW: firmware) are stored is connected to the first circuit control bus 105 via a ROM controller 109. A clock controller 110 is also connected to the first circuit control bus 105. The clock controller 110 supplies a reset signal and a clock signal to each component in response to the power-on reset signal from the power supply circuit 103.

The second circuit control bus 106 is connected to the first circuit control bus 105. A parallel IO (PIO) circuit 111 for supplying a status display signal to the status display LED and a serial IO (SIO) circuit 112 for controlling the RS232C interface are connected to the second circuit control bus 106.

An ATA interface controller (ATA controller) 113, a first error check and correct (ECC) circuit 114, a NAND controller 115, and a DRAM controller 119 are connected to both the data access bus 104 and the first circuit control bus 105. The ATA controller 113 sends/receives data to/from the host device via an ATA interface. An SRAM 120 used as a data work space is connected to the data access bus 104 via an SRAM controller 121.

The NAND controller 115 includes a NAND interface circuit 118 which interfaces with four NAND flash memories 200, a controller 117, and a DMA transfer control DMA controller 116 for controlling accesses to NAND type flash memory DRAMs. The controller 117 has the function of the memory management device 14 described in the first to fourth embodiments. That is, the controller 117 includes the NAND processing unit 30, the storage unit 31, and the NAND controller 33 that have been described with reference to FIG. 2, and performs the operations described in the first to fourth embodiments.

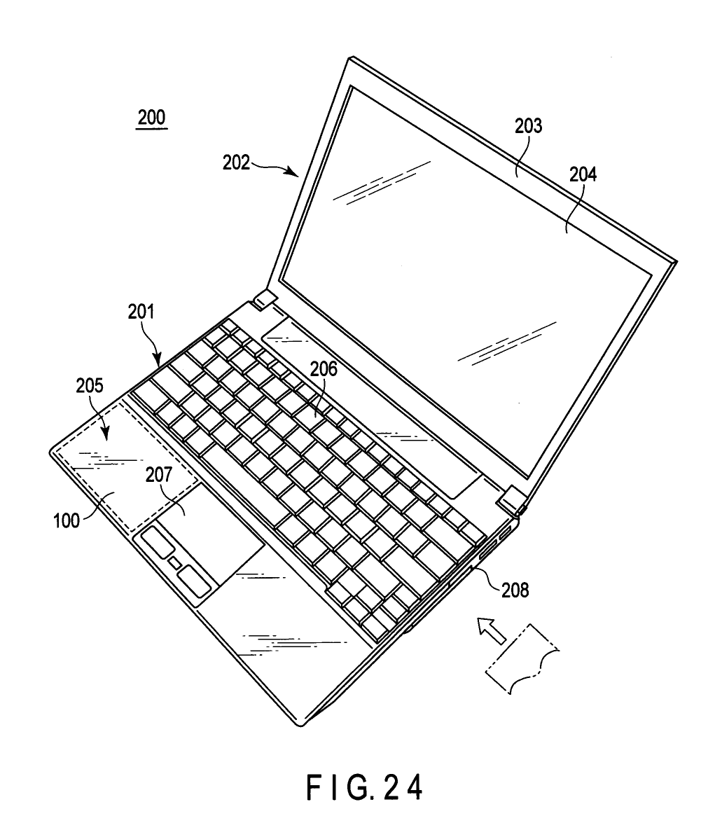

FIG. 24 is a perspective view showing an example of a portable computer 200 equipped with the SSD 100. The portable computer 200 includes a main body 201, and a display unit 202. The display unit 202 includes a display housing 203, and a display device 204 housed in the display housing 203.

### Modification and Others

As described above, the semiconductor device 1 according to the first to fifth embodiments includes the NAND flash memory 22 capable of holding data, the error correction unit 38 detecting and correcting errors in the data, and the table (the coloring table 35 or the address translation table 36) having information (ECC information) on the error correction method to be used for each piece of data. The error correction unit selects an error correction method to be applied for each piece of data in accordance with the information in the table.

According to this configuration, the minimum ECC circuit is only enabled in the error correction unit, and the power consumption of the semiconductor device 1 can be reduced.

It should be understood that the first to fifth embodiments described above can be modified. For example, two kinds of error correction methods are used in the first and second embodiments described above, and three kinds of error correction methods are used in the third embodiment. However, more kinds of error correction methods may be available. The data format adapted to each error correction method is not limited to the format described in the embodiments, and various formats may be used.

The ECC information may be recorded in the address translation table 36 rather than in the coloring table 35, or may be recorded in both the coloring table 35 and the address translation table 36.

The system that uses the NAND flash memory as the main memory is described as an example of the semiconductor device 1 in the first to fourth embodiments, and the SSD is described as an example of the semiconductor device 1 in the fifth embodiment. However, the embodiments are not limited to these systems. For example, the embodiments are also applicable to a system that does not use the NAND flash memory as the main memory, or to SD™ memory card. The coloring table described with reference to FIG. 3 is not particularly necessary in the examples of the SSD and the SD memory card. In this case, the ECC information may be provided from the host device. The nonvolatile semiconductor memory 22 is not exclusively a NAND flash memory and can be any other semiconductor memory in general. The storage device 20 is not exclusively a semiconductor memory and can be any error correction recording medium in general, such as a magnetic recording medium or an optical recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device comprising:
a NAND flash memory configured to hold data;
an error correction unit which detects and corrects errors in the data; and
a table which holds information on an error correction method associated with each piece of data,
wherein the error correction unit selects an error correction method to be applied for each piece of data in accordance with the information in the table.

2. The device according to claim 1, further comprising: a processor which executes an operating system and/or an application,
wherein the information is provided by the operating system and/or the application.

3. The device according to claim 1, wherein the error correction unit includes a first circuit adapted to a first error correction method and a second circuit adapted to a second error correction method, and
the first circuit and the second circuit are different in error correction capability.

4. The device according to claim 3, wherein the NAND flash memory collectively reads data from memory cells by a first unit, and
in writing, the first error correction method generates a parity by a second unit smaller than the first unit, and the second error correction method generates a parity by the first unit.

5. The device according to claim 4, wherein in the table, the first error correction method is associated with data that requires a first access speed, and
the second error correction method is associated with data that requires a second access speed lower than the first access speed.

6. The device according to claim 1, further comprising: a control unit which copies the data in the NAND flash memory,
wherein the control unit selects a space to copy data to in accordance with the error correction method in the table.

7. The device according to claim 6, wherein the error correction unit is configured to use a first error correction method, and a second error correction method higher in error correction capability and lower in speed than the first error correction method,
when data to be copied is associated with the first error correction method, the control unit selects a space having a first error frequency as the space to copy data to, and
when data to be copied is associated with the second error correction method, the control unit selects a space having a second error frequency higher than the first error frequency as the space to copy data to.

8. The device according to claim 7, wherein when the data to be copied is associated with the first error correction method and the space having the first error frequency is not selected as the space to copy data to,
the control unit selects the space having the second error frequency higher as the space to copy data to, and changes the error correction method from the first error correction method to the second error correction method at the time of copying.

9. The device according to claim 8, wherein the NAND flash memory is configured to write and read data page by page,
when the data to be copied is present in more than one page, the control unit combines the data in the pages into one page, and applies the second error correction method to the combined data and then writes the data to the space to copy data to.

10. The device according to claim 6, wherein the table further holds information on error frequency for each piece of data, and
the control unit copies the data when the error frequency is beyond a predetermined threshold.

11. A data access method of a semiconductor device which includes error correction units to detect and correct errors in data in accordance with error correction methods different from each other, the method comprising:
reading data from a NAND flash memory;
referring to a table for an error correction method applied to the read data;
activating an error correction unit corresponding to the error correction method applied to the read data and deactivating another error correction unit in accordance with the reference to the table; and
detecting and correcting errors in the read data by the enabled error correction unit.

12. The method according to claim 11, wherein the error correction units includes a first error correction unit adapted to a first error correction method and a second error correction unit adapted to a second error correction method, and
the first error correction unit and the second error correction unit are different in error correction capability.

13. The method according to claim 12, wherein the NAND flash memory collectively reads data from memory cells by a first unit, and
the first error correction method generates a parity by a second unit smaller than the first unit, and
the second error correction method generates a parity by the first unit.

14. The method according to claim 13, wherein in the table, the first error correction method is associated with data that requires a first access speed, and
the second error correction method is associated with data that requires a second access speed lower than the first access speed.

15. A data access method of a semiconductor device which includes error correction units to detect and correct errors in data in accordance with error correction methods different from each other, the method comprising:
referring to a table for an error correction method to be applied to write data;
activating an error correction unit corresponding to the error correction method to be applied to the write data and deactivating another error correction unit in accordance with the reference to the table;
generating a parity for the write data by the enabled error correction unit; and
writing the write data and the parity to a NAND flash memory.

16. The method according to claim 15, wherein the error correction unit includes a first error correction unit adapted to a first error correction method and a second error correction unit adapted to a second error correction method, and
the first error correction unit and the second error correction unit are different in error correction capability.

17. The method according to claim 16, wherein the NAND flash memory collectively reads data from memory cells by a first unit, and
the first error correction method generates a parity by a second unit smaller than the first unit, and
the second error correction method generates a parity by the first unit.

18. The method according to claim 17, wherein in the table, the first error correction method is associated with data that requires a first access speed, and
the second error correction method is associated with data that requires a second access speed lower than the first access speed.
